(19) United States
(12) Patent Application Publication
(10) Pub. No.: US 2021/0405459 A1
(43) Pub. Date: Dec. 30, 2021

(54) LIQUID CRYSTAL DISPLAY PANEL AND MANUFACTURING METHOD THEREOF

(71) Applicant: WUHAN CHINA STAR OPTOELECTRONICS TECHNOLOGY CO., LTD., Wuhan, Hubei (CN)

(72) Inventor: Zhenhui CHEN, Wuhan, Hubei (CN)

(21) Appl. No.: 16/631,755

(22) PCT Filed: Nov. 6, 2019
(86) PCT No.: PCT/CN2019/116014

§ 371 Date: Jan. 16, 2020

(30) Foreign Application Priority Data
Oct. 28, 2019 (CN) 201911028729.9

(51) Int. Cl. G02F 1/1337; G02F 1/1339

(52) U.S. Cl. CPC G02F 1/133711; G02F 1/1339; G02F 1/133788

(57) ABSTRACT

The present invention provides a liquid crystal display panel and a manufacturing method thereof. The liquid crystal display panel includes a first substrate, a liquid crystal layer, a second substrate, and a polymer wall disposed opposite to each other. The polymer wall is annularly disposed around an edge of the liquid crystal layer. The polymer wall is formed by curing the liquid crystal layer by ultraviolet irradiation. The liquid crystal layer comprises a liquid crystal molecule, an ultraviolet reactive monomer, a photoinitiator, and a polymerization inhibitor.

### FIELD OF INVENTION

The present invention relates to the field of display technologies, and in particular, to a liquid crystal display panel and a manufacturing method thereof.

### BACKGROUND OF INVENTION

Liquid crystal displays (LCDs) are most widely used display products on the market. Production process technologies of the LEDs are very mature, product yield of the LEDs is high, production costs of the LEDs are relatively low, and market acceptance of the LEDs is high. Due to increasingly narrower requirements on display frames at current market, full screens have become a standard for mobile phones, and an upper frame can achieve 0.5 mm in an extreme situation. Narrow frame designs for traditional LCDs have not fully met the needs of the market. Especially in a high-end mobile phone market, it faces fierce competition in active matrix organic light-emitting display (AMOLED) products.

In designs of current LCD frames, since packaging sealants have a certain pollution to a liquid crystal layer, a process generally requires that an edge of a sealant coating has a distance of 200 μm to 300 μm from a display area, so that further reducing a width of the frame is extremely challenging for materials and processes. Therefore, it is urgent to propose a new liquid crystal display panel and a manufacturing method thereof to solve the above problems.

### Technical Problem

An object of the present invention is to provide a liquid crystal display panel and a manufacturing method thereof by changing a composition of a liquid crystal layer, and forming a polymer wall by ultraviolet irradiation on both ends of the liquid crystal layer to package the liquid crystal layer, thereby realizing a narrow frame of the liquid crystal display panel.

### Technical Solution

In order to achieve the above object, the present invention provides the following technical solutions:

The present invention provides a liquid crystal display panel comprising a first substrate and a second substrate disposed opposite to each other, and a liquid crystal layer filled in a space between the first substrate and the second substrate. The liquid crystal display panel further comprises a polymer wall annularly disposed around an edge of the liquid crystal layer, a lower surface of the polymer wall is connected to an upper surface of the first substrate, and an upper surface of the polymer wall is connected to a lower surface of the second substrate. The polymer wall is formed by curing the liquid crystal layer by ultraviolet irradiation. The liquid crystal layer comprises a liquid crystal molecule, an ultraviolet reactive monomer, a photoinitiator, and a polymerization inhibitor.

Further, the polymer wall has a width ranging from 200 um to 300 um.

Further, a weight percentage of the ultraviolet reactive monomer is 0.2% to 50%.

Further, the ultraviolet reactive monomer comprises an acrylate monomer containing a carbon-carbon double bond.

Further, a chemical structural formula of the carbon-carbon double bond of the acrylate monomer comprises one or more of

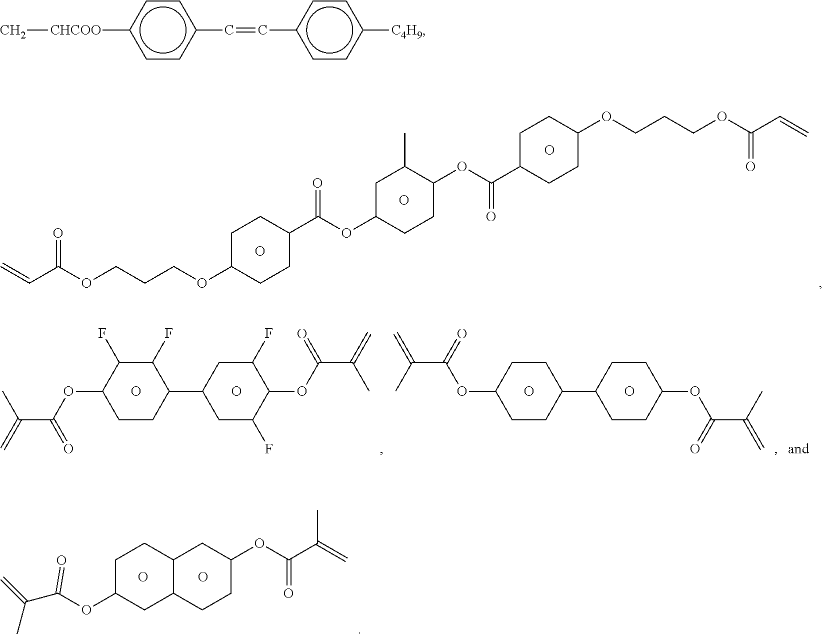

Further, the photoinitiator is one or more of an acetophenone photoinitiator, a bisimidazole photoinitiator, a benzoin photoinitiator, a benzophenone photoinitiator, and a quinoxaline photoinitiator.

Further, the polymerization inhibitor is one or more of tert-butyl catechol, p-phenol monobutyl ether, and hydroquinone.

Further, the liquid crystal layer further comprises an antioxidant, and the antioxidant is a phosphate-based antioxidant or a halogen acid.

The present invention provides a manufacturing method of a liquid crystal display panel, comprising the following steps:

S1: providing a first substrate and a second substrate;

S2: forming a sealant on the first substrate, and forming a liquid crystal layer in the sealant, wherein the liquid crystal layer comprises a liquid crystal molecule, an ultraviolet reactive monomer, a photoinitiator, and a polymerization inhibitor;

S3: disposing the second substrate on the sealant and the liquid crystal layer;

S4: providing a mask above the second substrate, wherein the mask is provided with a light transmissive region annularly surrounding an edge of the liquid crystal panel at a position corresponding to a contact between the liquid crystal layer and the sealant, a portion of the light transmissive region corresponds to the liquid crystal layer, and another portion of the light transmissive region corresponds to the sealant;

S5: forming a polymer wall in a region where the liquid crystal layer overlapping the corresponding light transmitting region by ultraviolet irradiation over the mask; photocuring a region where the sealant overlapping the corresponding light transmitting region by the ultraviolet irradiation over the mask; wherein the polymer wall is annularly disposed around an edge of the liquid crystal layer, a lower surface of the polymer wall is connected to an upper surface of the first substrate, and an upper surface of the polymer wall is connected to a lower surface of the second substrate; and wherein the sealant is annularly disposed around the polymer wall, a lower surface of the sealant is connected to the upper surface of the first substrate, and an upper surface of the sealant is connected to the lower surface of the second substrate; and

S6: cutting a portion between the polymer wall and the sealant, removing the sealant, leaving only the polymer wall, and obtaining a liquid crystal display panel.

Further, after the liquid crystal layer is cured by the ultraviolet irradiation to form the polymer wall, further comprises a baking curing step: a baking temperature is 90° C. to 120° C., and a baking time is 30 min to 60 min.

### Beneficial Effect

The present invention provides a liquid crystal display panel and a manufacturing method thereof. By changing a composition of a liquid crystal layer, and forming a polymer wall by ultraviolet irradiation on both ends of the liquid crystal layer to package the liquid crystal layer, thereby realizing a narrow frame of the liquid crystal display panel.

### DESCRIPTION OF DRAWINGS

FIG. 1 is a schematic view of a liquid crystal display panel according to an embodiment of the present invention.

FIG. 2 is a flowchart of a manufacturing method of the liquid crystal display panel according to the embodiment of the present invention.

FIG. 3 is a schematic structural view of a process of forming a polymer wall by curing a liquid crystal layer by ultraviolet irradiation after setting a mask.

Reference numerals in the drawings are as follows:
1: first substrate; 2: liquid crystal layer; 3: second substrate; 4: polymer wall; 5: sealant; 10: liquid crystal display panel; 20: mask; 21: light transmissive region.

### DETAILED DESCRIPTION OF PREFERRED EMBODIMENTS

In the present invention, the terms “installation”, “connected”, “connected”, “fixed”, etc., should be understood broadly unless otherwise clearly required and defined. For example, it can be a fixed connection, or it can be a detachable connection, or integrated; it can be mechanical or electrical connection; it can be directly connected or indirectly connected through an intermediary; it can be an internal connection of two components or an interaction of two components. For those skilled in the art, the specific meanings of the above terms in the present invention can be understood according to the specific circumstances.

The technical solutions in the embodiments of the present invention are clearly and completely described in the following with reference to the accompanying drawings in the embodiments of the present invention. Obviously, the described embodiments are only a part of the embodiments of the present invention, and not all of the embodiments. All other embodiments obtained by those skilled in the art based on the embodiments of the present invention without creative efforts are within the scope of the present invention.

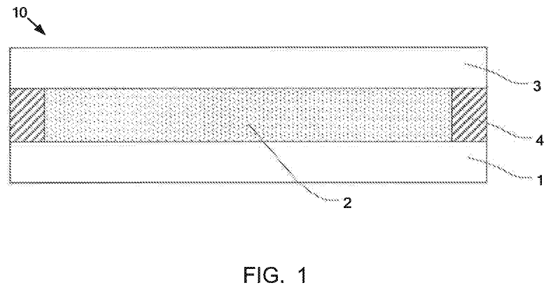

As shown in FIG. 1, an embodiment of the present invention provides a liquid crystal display panel 10 comprising a first substrate 1 and a second substrate 3 disposed opposite to each other, and a liquid crystal layer 2 filled in a space between the first substrate 1 and the second substrate 3. The liquid crystal display panel 10 further comprises a polymer wall 4 annularly disposed around an edge of the liquid crystal layer 2, a lower surface thereof is connected to an upper surface of the first substrate 1, and an upper surface thereof is connected to a lower surface of the second substrate 3. The polymer wall 4 is formed by curing the liquid crystal layer 2 by ultraviolet irradiation. The liquid crystal layer 2 comprises a liquid crystal molecule, an ultraviolet reactive monomer, a photoinitiator, and a polymerization inhibitor.

Wherein, an ultraviolet irradiation time is from 60 s to 200 min, and an illuminance of the ultraviolet is in a range of 10 mW/cm² to 200 mW/cm², preferably 10 mW/cm² to 100 mW/cm². After the liquid crystal layer 2 is cured by the ultraviolet irradiation to form the polymer wall 4, further comprises a baking curing step. A baking curing can further strengthen strength and stability of the polymer wall 4 and the sealant 5. A baking temperature is 90° C. to 120° C., and a baking time is 30 min to 60 min.

In the embodiment, the polymer wall 4 has a width ranging from 200 um to 300 um.

In the embodiment, a weight percentage of the ultraviolet reactive monomer is 0.2% to 50%.

In the embodiment, the ultraviolet reactive monomer comprises an acrylate monomer containing a carbon-carbon double bond.

In the embodiment, a chemical structural formula of the carbon-carbon double bond of the acrylate monomer comprises one or more of

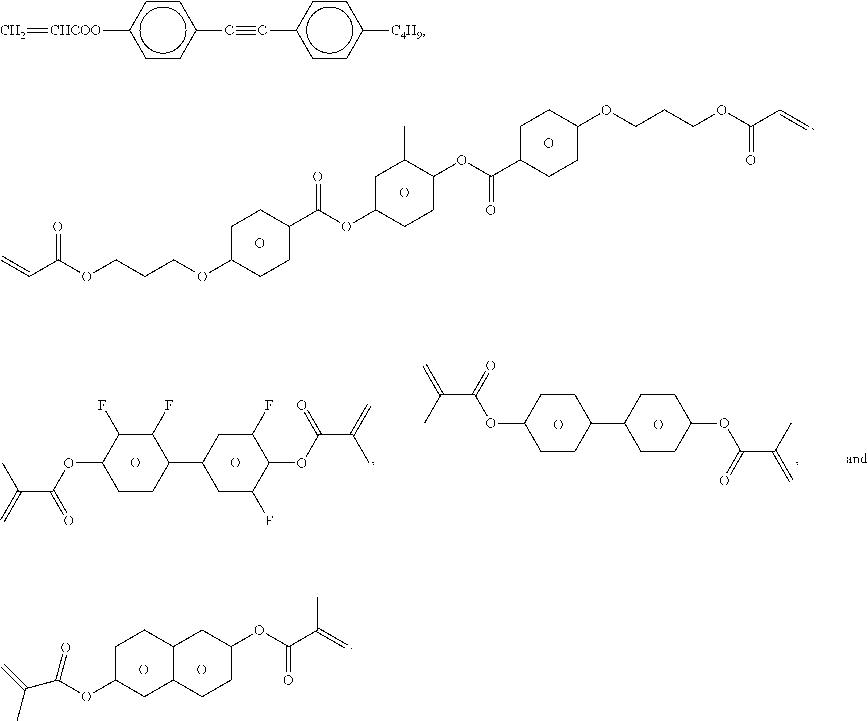

Wherein, the liquid crystal molecule may be a positive liquid crystal molecule or a negative liquid crystal molecule, and a structural formula of the liquid crystal molecule comprises one or more of

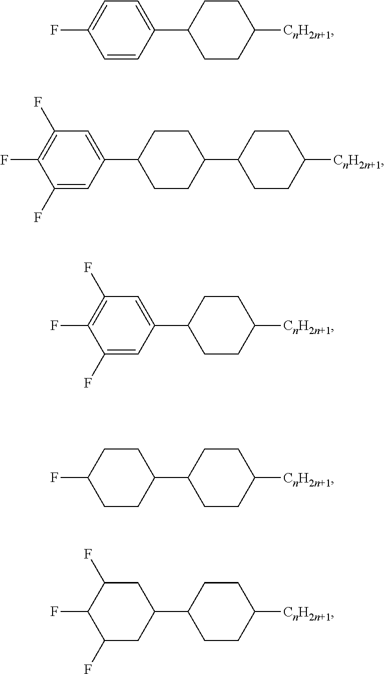

where n=3, 4, 5, 6, 7, and 8.

In the embodiment, the photoinitiator is one or more of an acetophenone photoinitiator, a bisimidazole photoinitiator, a benzoin photoinitiator, a benzophenone photoinitiator, and a quinoxaline photoinitiator. Wherein, the benzoin photoinitiator is also called benzoin photoinitiator. A role of the liquid crystal layer 2 in forming the polymer wall 4 by ultraviolet irradiation curing is that an induced monomer of the photoinitiator forms a radical, and the radical undergoes a polymerization reaction.

In order to prevent a reaction of the reactive monomer in a subsequent step from being too intense, the polymer wall 4 is formed in a display region to affect the liquid crystal display, and the polymerization inhibitor or the antioxidant is further added to materials of the liquid crystal. The polymerization inhibitor is one or more of tert-butyl catechol, p-phenol monobutyl ether, and hydroquinone. The antioxidant is a phosphate-based antioxidant or a halogen acid.

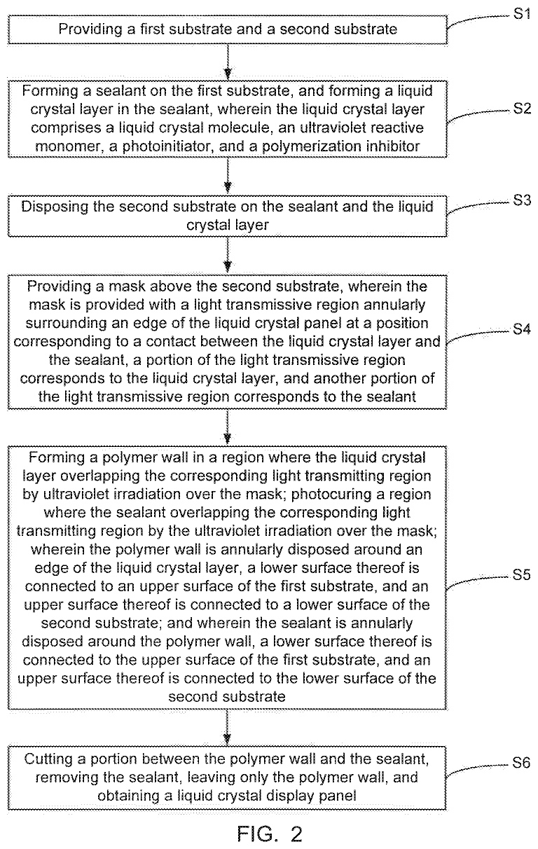

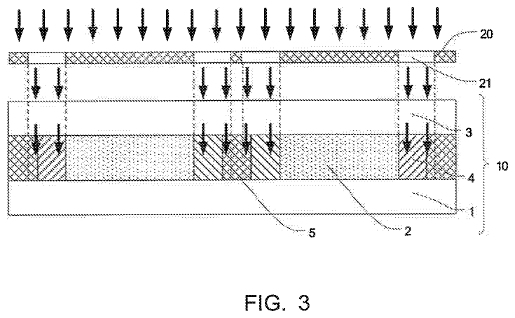

As shown in FIG. 2 and FIG. 3, the present invention provides a manufacturing method of a liquid crystal display panel 10, which comprise the following steps:

S1: providing a first substrate 1 and a second substrate 3. The first substrate 1 and the second substrate 3 may also be carried by a carrier substrate.

S2: forming a sealant 5 on the first substrate 1, and forming a liquid crystal layer 2 in the sealant 5. The liquid crystal layer comprises a liquid crystal molecule, an ultraviolet reactive monomer, a photoinitiator, and a polymerization inhibitor.

S3: disposing the second substrate 3 on the sealant 5 and the liquid crystal layer 2.

S4: providing a mask 20 above the second substrate 3, wherein the mask 20 is provided with a light transmissive region 21 annularly surrounding an edge of the liquid crystal panel at a position corresponding to a contact between the liquid crystal layer 2 and the sealant 5. A width of the light transmissive region 21 is 300 um-500 um. A portion of the light transmissive region corresponds to the liquid crystal layer, and has a width ranging from 200 um to 300 um. Another portion of the light transmissive region corresponds to the sealant.

S5: forming a polymer wall 4 in a region where the liquid crystal layer 2 overlapping the corresponding light transmitting region 21 by ultraviolet irradiation (indicated by arrows in FIG. 3) over the mask 20; photocuring a region where the sealant 5 overlapping the corresponding light transmitting region 21 by the ultraviolet irradiation (indicated by arrows in FIG. 3) over the mask 20; wherein the polymer wall 4 is annularly disposed around an edge of the liquid crystal layer 2, a lower surface thereof is connected to an upper surface of the first substrate 1, and an upper surface thereof is connected to a lower surface of the second substrate 3; and wherein the sealant 5 is annularly disposed around the polymer wall 4, a lower surface thereof is connected to the upper surface of the first substrate 1, and an upper surface thereof is connected to the lower surface of the second substrate 3; and

S6: cutting a portion between the polymer wall 4 and the sealant 5, removing the sealant 5, leaving only the polymerwall 4, and obtaining a liquid crystal display panel 10.

Wherein, the sealant 5 specifically comprises at least one resin of 20%-60% of acrylate resin, 10%-30% of epoxy resin, and 10%-30% of polytetrafluoroethylene resin; 1%-5% of organic amine hardener, 10%-30% of silicon ball or fiber filler, 1%-5% of silane coupling agent, and 1%-5% of acetophenone photoinitiator, and all percentages above represent mass percentage.

In addition, the ultraviolet reactive monomer comprises an acrylate monomer containing a carbon-carbon double bond. Wherein a weight percentage of the ultraviolet light reactive monomer is from 0.2 wt % to 50 wt %.

A chemical structural formula of the carbon-carbon double bond of the acrylate monomer comprises one or more of

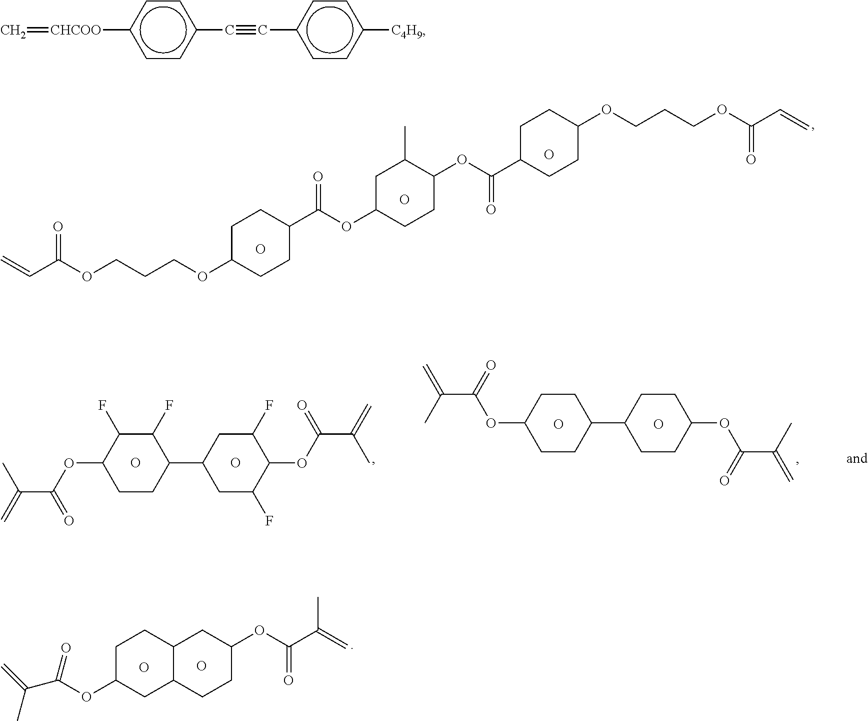

Wherein, the liquid crystal molecule may be a positive liquid crystal molecule or a negative liquid crystal molecule, and a structural formula of the liquid crystal molecule comprises one or more of

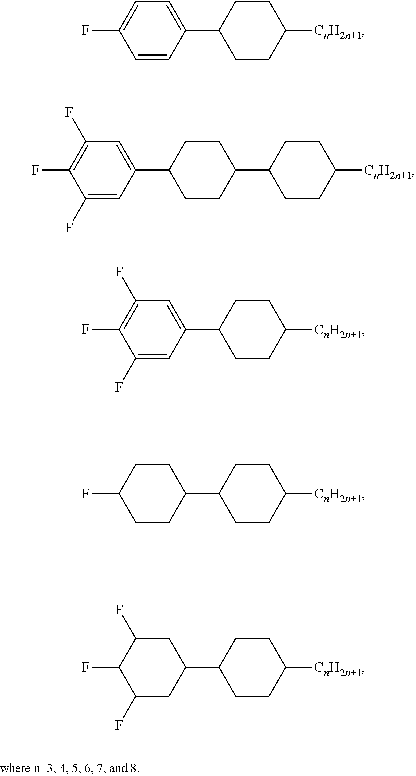

In the embodiment, the photoinitiator is one or more of an acetophenone photoinitiator, a bisimidazole photoinitiator, a benzoin photoinitiator, a benzophenone photoinitiator, and a quinoxaline photoinitiator. Wherein, the benzoin photoinitiator is also called benzoin photoinitiator. A role of the liquid crystal layer 2 in forming the polymerwall 4 by ultraviolet irradiation curing is that an induced monomer of the photoinitiator forms a radical, and the radical undergoes a polymerization reaction.

In order to prevent a reaction of the reactive monomer in a subsequent step from being too intense, the polymer wall 4 is formed in the display region to affect the liquid crystal display, and the polymerization inhibitor or the antioxidant is further added to materials of the liquid crystal. The polymerization inhibitor is one or more of tert-butyl catechol, p-phenol monobutyl ether, and hydroquinone. The antioxidant is a phosphate-based antioxidant or a halogen acid.

In the embodiment, after the liquid crystal layer 2 is cured by the ultraviolet irradiation to form the polymer wall 4, further comprises a baking curing step: a baking temperature is 90° C. to 120° C., and a baking time is 30 min to 60 min. A baking curing can further strengthen the strength and stability of the polymer wall 4. Under high temperature conditions, the acrylate resin is further reacted, and the epoxy resin is polymerized to increase the curing rate of the sealant 5.

The present invention provides a liquid crystal display panel 10 and a manufacturing method thereof. By changing a composition of a liquid crystal layer 2, and forming a polymer wall 4 by ultraviolet irradiation on both ends of the liquid crystal layer 2 to package the liquid crystal layer 2, thereby realizing a narrow frame of the liquid crystal display panel 10.

In the above, various other corresponding changes and modifications can be made according to the technical solutions and technical ideas of the present invention to those skilled in the art, and all such changes and modifications are within the scope of the claims of the present invention.

What is claimed is:

1. A liquid crystal display panel, comprising:
a first substrate and a second substrate disposed opposite to each other, and a liquid crystal layer filled in a space between the first substrate and the second substrate;
wherein the liquid crystal display panel further comprises a polymer wall annularly disposed around an edge of the liquid crystal layer, a lower surface of the polymer wall is connected to an upper surface of the first substrate, and an upper surface of the polymer wall is connected to a lower surface of the second substrate;
wherein the polymer wall is formed by curing the liquid crystal layer by ultraviolet irradiation; and
wherein the liquid crystal layer comprises a liquid crystal molecule, an ultraviolet reactive monomer, a photoinitiator, and a polymerization inhibitor.

2. The liquid crystal display panel as claimed in claim 1, wherein the polymer wall has a width ranging from 200 um to 300 um.

3. The liquid crystal display panel as claimed in claim 1, wherein a weight percentage of the ultraviolet reactive monomer is 0.2% to 50%.

4. The liquid crystal display panel as claimed in claim 1, wherein the ultraviolet reactive monomer comprises an acrylate monomer containing a carbon-carbon double bond.

5. The liquid crystal display panel as claimed in claim 4, wherein a chemical structural formula of the carbon-carbon double bond of the acrylate monomer comprises one or more of

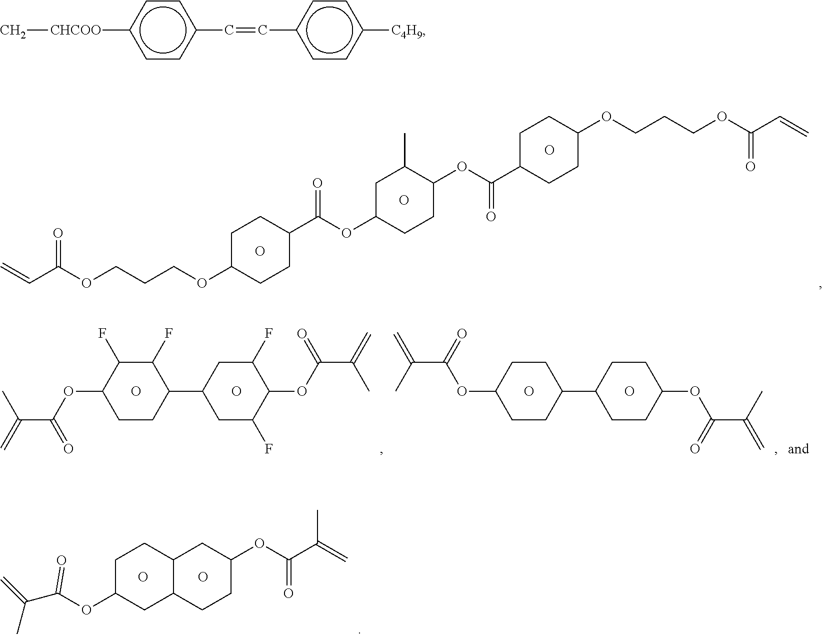

6. The liquid crystal display panel as claimed in claim 1, wherein the photoinitiator is one or more of an acetophenone photoinitiator, a bisimidazole photoinitiator, a benzoin photoinitiator, a benzophenone photoinitiator, and a quinoxaline photoinitiator.

7. The liquid crystal display panel as claimed in claim 1, wherein the polymerization inhibitor is one or more of tert-butyl catechol, p-phenol monobutyl ether, and hydroquinone.

8. The liquid crystal display panel as claimed in claim 1, wherein the liquid crystal layer further comprises an antioxidant, and the antioxidant is a phosphate-based antioxidant or a halogen acid.

9. A manufacturing method of a liquid crystal display panel, comprising the following steps:
S1: providing a first substrate and a second substrate;
S2: forming a sealant on the first substrate, and forming a liquid crystal layer in the sealant, wherein the liquid crystal layer comprises a liquid crystal molecule, an ultraviolet reactive monomer, a photoinitiator, and a polymerization inhibitor;
S3: disposing the second substrate on the sealant and the liquid crystal layer;
S4: providing a mask above the second substrate, wherein the mask is provided with a light transmissive region annularly surrounding an edge of the liquid crystal panel at a position corresponding to a contact between the liquid crystal layer and the sealant, a portion of the light transmissive region corresponds to the liquid crystal layer, and another portion of the light transmissive region corresponds to the sealant;
S5: forming a polymer wall in a region where the liquid crystal layer overlapping the corresponding light transmitting region by ultraviolet irradiation over the mask; photocuring a region where the sealant overlapping the corresponding light transmitting region by the ultraviolet irradiation over the mask; wherein the polymer wall is annularly disposed around an edge of the liquid crystal layer, a lower surface of the polymer wall is connected to an upper surface of the first substrate, and an upper surface of the polymer wall is connected to a lower surface of the second substrate; and wherein the sealant is annularly disposed around the polymer wall, a lower surface of the sealant is connected to the upper surface of the first substrate, and an upper surface of the sealant is connected to the lower surface of the second substrate; and
S6: cutting a portion between the polymer wall and the sealant, removing the sealant, leaving only the polymer wall, and obtaining a liquid crystal display panel.

10. The manufacturing method of the liquid crystal display panel as claimed in claim 9, wherein after the liquid crystal layer is cured by the ultraviolet irradiation to form the polymer wall, further comprises a baking curing step: a baking temperature is 90° C. to 120° C., and a baking time is 30 min to 60 min.
